(19) United States
(12) Patent Application Publication
(10) Pub. No.: US 2002/0176382 A1
(43) Pub. Date: Nov. 28, 2002

(54) Method and system for integration of second generation and third generation wireless networks

(75) Inventors: Lila Madour, Kirkland (CA); David Kunz, St-Philippe (CA); Franco Capitina, Kirkland (CA)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ)

(21) Appl. No.: 09/865,648

(22) Filed: May 24, 2001

(51) Int. Cl. H04Q 7/00

(52) U.S. Cl. 370/331; 370/338; 455/439

(57) ABSTRACT

An inter-working function in a second generation wireless network is used as a transition node for provision of packet-data services by a packet-data service node located in a third generation network. Mobile stations operating in the second generation network that request packet-data services are connected to the packet-data service node via the inter-working function, wherein the inter-working function extends a point-to-point protocol connection between the mobile station and the packet-data service node. In the event that the mobile station roams between the second generation and the third generation networks, either dormant or hard handoff procedures can be employed that allow a previously-established point-to-point protocol connection to be reused without being renegotiated following the handoff.

### TECHNICAL FIELD OF INVENTION

The present invention relates to wireless communication systems in general and, in particular, to provision of third-generation services to mobile stations operating in second-generation networks and to enhanced roaming of mobile stations between second generation and third generation wireless networks by enabling integration of second generation infrastructures with third generation infrastructures.

### BACKGROUND

Advancements in the fields of electronics and communications have permitted the introduction and commercialization of many new types of communications systems. Information can be affordably communicated to locations in manners previously not possible or affordable.

The field of cellular telephony is exemplary of a communications system that has been made possible due to such advancements. Communication using a cellular telephone is advantageous because a fixed, wireline connection is not required between a sending station and a receiving station to permit communications to be effectuated therebetween. A cellular communication system is, therefore, particularly advantageous to effectuate communications when the use of fixed or hard-wired connections would be inconvenient or impractical. Continued advancements in the field of cellular telephony, as well as other types of radio-telephonic communications, have permitted the introduction of new services and new forms of communication pursuant to already installed cellular, and other radio-telephonic, networks.

Proposals have been set forth to provide existing cellular, and other communication, networks with the capability of communicating packet data in which information to be transmitted between a sending station and a receiving station is formed into discrete packets of data. Individual packets of data can be sent on a communication channel from the sending station to the receiving station. Because the information is communicated by way of discrete packets, the sending station needs to utilize the channel only during time periods required to send the discrete packets. A channel is typically, therefore, a shared channel used by a plurality of sending stations.

To communicate a packet of data to a mobile station, the packet must be addressed with an identification address of the mobile station. An Internet protocol (IP) address is exemplary of an identification address that can be used to address packets of data that are to be relayed to the mobile station. The IP address is, of course, utilized when transmissions are made pursuant to the Internet protocol. Many different types of services have been implemented that are effectuated by the communication of packet data according to various protocols.

Second generation code division multiple access (CDMA) cellular networks use an interworking function (IWF) to provide access to packet data services; however, second generation CDMA networks typically cannot provide advanced functionality and faster data rates sought by many users, such as, for example, a data service option known as a high-speed data service option. One of the problems with second-generation packet data services is that second-generation standards have defined use of the interworking function to allow second-generation mobile stations to have access to the Internet or another packet data network, but the second-generation standards have specified very little intent regarding the interworking function except for the requirement that a connection between mobile stations and the interworking function is a point-to-point-protocol connection. According to the second-generation standards, the interworking function connects to an external network so that the mobile stations can access packet data services.

In contrast, third-generation services include a packet data service node (PDSN), which also utilizes PPP connections. However, more functions have been defined in the packet data service node to support mobile stations. Principal advantages of the packet data service node over the interworking function include an interconnection to an authentication, authorization, and accounting (AAA) server, incorporation of an AAA client, and support of mobile Internet protocol (Mobile IP). Each of these has been specified in the third-generation standard.

CDMA2000 is a third-generation standard that permits increased data transmission rates in code division multiple access systems. A high speed data service option operates at 144 kilobits per second (kbps) and is available in third generation CDMA (e.g. CDMA2000) networks. The high-speed data service option is defined in the TIA/TSB 58 Rev. B standard. This standard mandates that third generation networks, such as those operating according to CDMA2000, allocate resources in a packet data service node in order to service requests for high-speed data service.

The point-to-point protocol (PPP) is the protocol used by the CDMA2000 wireless communication standard for communications between mobile stations and PDSNs. A packet data session between a mobile station and a packet data service node is referred to as a PPP connection. In practice, an interworking function is a resource used for low data rates (e.g., 9.6 or 14.4 kbps) and a packet data service node is used for high speed data services (e.g., 144 kbps). When a PPP connection is made with a PDSN, a PPP connection terminates in the packet data service node, wherein AAA services are initiated. In contrast, interworking functions only provide access to an external network, most typically via an external network access server (NAS), and do not provide AAA services. Rather, in second generation networks that use an IWF, AAA services are handled by a mobile switching center (MSC) serving the mobile station and by the external network to which the mobile station is connected.

Because current, second-generation, CDMA networks do not provide the system capacity, advanced features, and improved networking that many users want, a migration to third-generation CDMA (e.g., CDMA2000) is ongoing. In particular, a need for enhanced wireless packet data services has been driving a move toward third-generation CDMA such as CDMA2000. Increased personal mobility, use of personal computing, and data communications that have resulted from the growth of the Internet, as well as a demand for multi-media applications, have created a greater need for faster data rates and other enhanced services not available in second-generation CDMA networks but which are provided by third-generation CDMA networks.

Therefore, many second-generation network operators that currently use interworking functions in their networks want to upgrade their networks to third generation functionality, including functions such as those provided by packet data service nodes. However, these second-generation network operators are often concerned that the existing infrastructure of their second-generation networks would be wasted and/or that services to current users could be detrimentally affected by an upgrade to third-generation functionality. It would therefore be desirable if packet data service node functionality could be added to second generation networks as an incremental upgrade without detrimentally affecting existing infrastructure or services of the second-generation networks.

Because the advanced features of the packet data service node, such as, for example, Mobile IP and AAA services are not available via an interworking function, these features either need to be incorporated into the interworking function or accessed from another entity. It would be uneconomical to attempt to rebuild all of the functionalities of the packet data service node into the interworking function; therefore it would be preferable if the PDSN functionalities could be accessed by the IWF using another entity.

When a mobile station operating in a second-generation network accesses services via the interworking function from the external NAS, roaming is not supported because there is a fixed connection between the interworking function and the external NAS. It would therefore be desirable that a solution to the above-mentioned problems be able to permit roaming between second-generation and third-generation networks in accordance with existing standards.

### SUMMARY OF THE INVENTION

These and other problems of the prior art are solved by the present invention. A method of providing packet data services includes requesting of packet-data services by a user located in a first network and assigning access resources to the user in an inter-working function of the first network. A link is established by the inter-working function to a packet data service node in a second network. A point-to-point protocol connection is negotiated via the inter-working function between the user in the first network and the packet data service node in the second network and the packet data services are provided to the user via the inter-working function by the packet data service node.

A system for providing packet data services includes an inter-working function, a packet data service node, and at least one mobile station. The interworking function is located in a first network and serves as a transition node between a packet data service node located in a second network and at least one mobile station. The packet data service node is located in the second network and is interoperably connected to the inter-working function. The at least one mobile station is located in the first network and is interoperably connected to the interworking function. The at least one mobile station receives services from the packet data service node via the inter-working function.

An inter-working function is located in a first network and interoperably connected to a packet data service node located in a second network. The interworking function is also interoperably connected to at least one mobile station located in the first network. The inter-working function serves as a transition node between the at least one mobile station and the packet data service node for provision of packet data services by the packet data service node to the at least one mobile station.

### BRIEF DESCRIPTION OF THE DRAWINGS

A more complete understanding of the method and system of the present invention may be acquired by reference to the following Detailed Description when taken in conjunction with the accompanying Drawings, wherein:

FIG. 1 is a block diagram illustrating integration of an interworking function of a second-generation network with a packet data service node of a third-generation network in accordance with the present invention;

FIG. 2 is a flow chart illustrating access of third-generation services from a packet data service node by a mobile station operating in a second-generation network in accordance with the present invention;

FIG. 3 is a messaging diagram illustrating origination of third-generation services by a mobile station operating in a second-generation network in accordance with the present invention;

FIG. 4 is a flow chart illustrating a dormant handoff of a mobile station operating in a second-generation network to a third-generation network in accordance with the present invention; and

FIG. 5 is a messaging diagram illustrating a hard handoff of a mobile station roaming from a second-generation network to a third-generation network in accordance with the present invention.

### DETAILED DESCRIPTION OF THE DRAWINGS

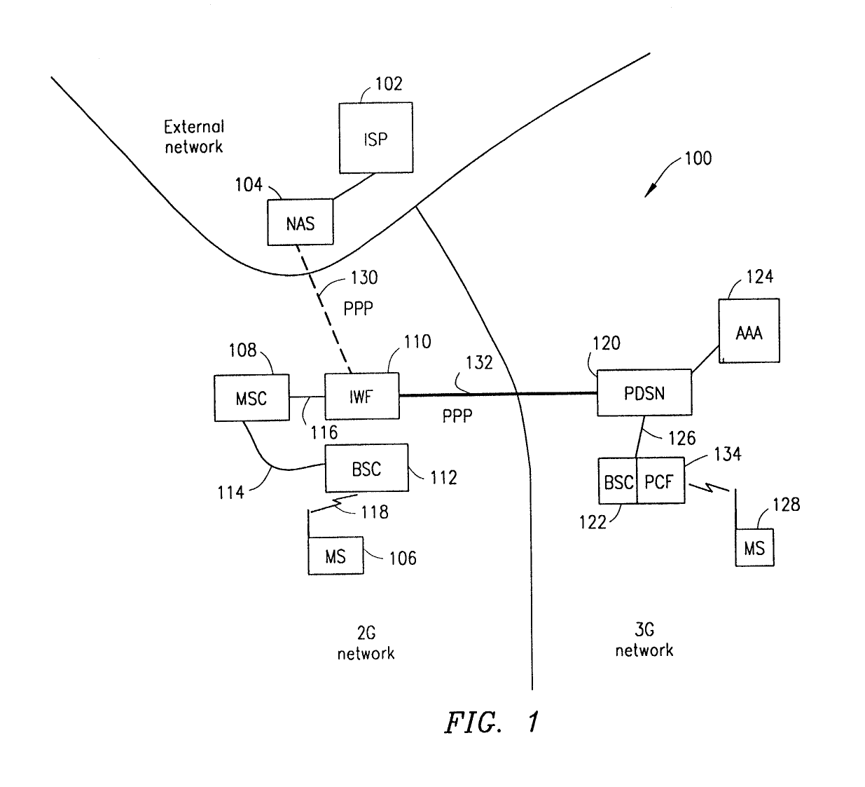

Reference is now made to FIG. 1, wherein there is shown a block diagram illustrating integration of an interworking function (IWF) of a second-generation network with a packet data service node (PDSN) of a third generation network in accordance with the present invention. FIG. 1 illustrates a communication system 100 that includes a second-generation (2G) network and a third-generation (3G) network. The second-generation network could be, for example, a second generation code division multiple access (CDMA) system operating according to IS-95 and the third generation network could be, for example, a third generation CDMA system operating according to CDMA2000. Also shown is an external network that includes, for example, an Internet service provider (ISP) 102 and a network access server (NAS) 104.

The second-generation network includes a mobile station 106, a mobile switching center (MSC) 108, an interworking function (IWF) 110, and a base station controller (BSC) 112. The mobile switching center 108 is interoperably connected to the base station controller 112 by a connection 114 and to the interworking function 110 by a connection 116. The mobile station 106 communicates with the base station controller 112 via an air interface connection 118. The interworking function 110 is utilized by the mobile station 106, when, for example, the mobile station 106 accesses packet data services.

The third-generation network includes a packet data service node (PDSN) 120, a base station controller BSC 122, a packet control function (PCF) 134 co-located with the BSC 122, and an authentication, authorization, and accounting (AAA) server 124. The PDSN 120 communicates with the BSC 122 and the PCF 134 via a connection 126. The PDSN 120 can be used by a mobile station 128 located in the 3G network to access third-generation services, such as, for example, a high-speed data service option (e.g., service option 33). The mobile stations 106 and 128 can be either 2G or 3G mobile stations. Although the 3G network shown in FIG. 1 is a third-generation CDMA network, the 3G network could instead be a second-generation CDMA network that includes the PDSN 120 as the result of, for example, an incremental upgrade to 3G functionality.

The interworking function 110 can connect to either the NAS 104 via a connection 130 (shown as a dashed line) or to the PDSN 120 of the 3G network via a connection 132. Both the connection 130 and the connection 132 are point-to-point protocol (PPP) connections. When the interworking function 110 connects to the PDSN 120 via the PPP connection 132, the PDSN 120 in effect serves as a network access server to the interworking function 110. When the interworking function 110 and the PDSN 120 are connected via the PPP connection 132, the PDSN 120 can provide AAA services to the mobile station 106 and can also provide 3G services, such as, for example, high-speed packet data services, that would otherwise be unavailable to the mobile station 106 because the mobile station 106 is currently operating in the 2G network. The IWF 110 serves as a transit node for provision of third-generation services by the PDSN 120 to the mobile station 106. The PDSN 120 supports accesses by the interworking function 110 on behalf of the mobile station 106. Because the PDSN 120 is used as a network access server to the interworking function 110, network operators can more easily establish and justify installation of a PDSN in their networks and can incrementally support third-generation access directly by users of the second-generation network. The PDSN 120 could be accessible by the IWF 110 as a result of an agreement between an operator of the 2G network and an operator of the 3G network. In addition, the PDSN 120 can provide functions similar to those provided by the network access server 104 from within the 2G network in support of mobile stations operating in the second-generation network.

It can thus be seen from FIG. 1 that the interworking function 110 in the 2G network can use the PDSN 120 of the 3G network for 3G services such as high-speed packet data services sought by mobile stations operating in the second-generation network. As a result, high-speed data services and other 3G services are made available to mobile stations operating in the second generation network.

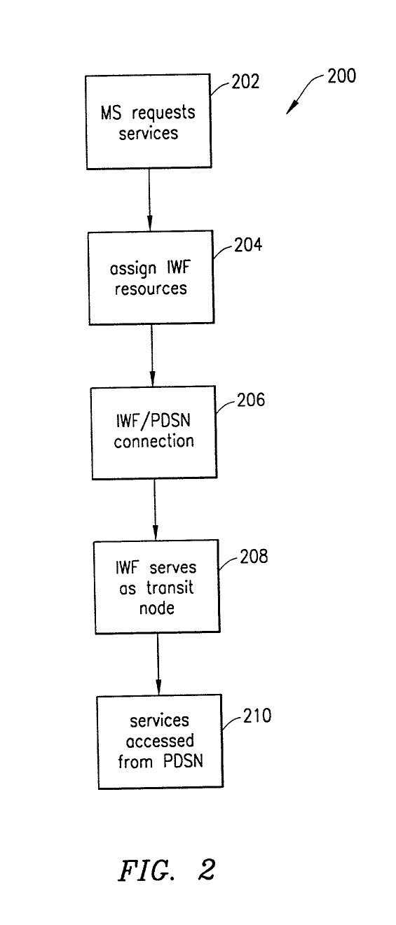

Reference is now made to FIG. 2, wherein there is shown a flow chart illustrating an access of the PDSN 120 for 3G services, such as, for example, high-speed data services, by the mobile station 106 in the 2G network in accordance with the present invention. A process 200 begins at step 202, wherein the mobile station 106, which is operating in the 2G network, requests 3G services, such as, for example, high-speed data services from the 2G network. From step 202, execution proceeds to step 204, wherein the 2G network negotiates access for the mobile station 106 by assigning access resources in the interworking function 110.

From step 204, execution proceeds to step 206. At step 206, the interworking function 110 establishes the connection 118 with the mobile station 106 and the PPP connection 132 with the PDSN 120. From step 206, execution proceeds to step 208. At step 208, the interworking function 110 serves as a transit node between the mobile station 106 and the PDSN 120 so that the PDSN 120 can negotiate the PPP connection 132 with the mobile station 106. From step 208, execution proceeds to step 210. At step 210, following completion of the negotiation of the PPP connection 132 of step 208, the mobile station 106 accesses, from the PDSN 120 and via the IWF 110, the high-speed data services requested by the mobile station 106 at step 202.

It can thus be seen from FIG. 2 that the mobile station 106, which is operating in the 2G network, requests 3G services, such as, for example, high-speed data services using the interworking function 110 of the 2G network. The interworking function 110 operates as a transit node to permit the mobile station 106 in the 2G network to access 3G services that are not available from the IWF 110 in the 2G network.

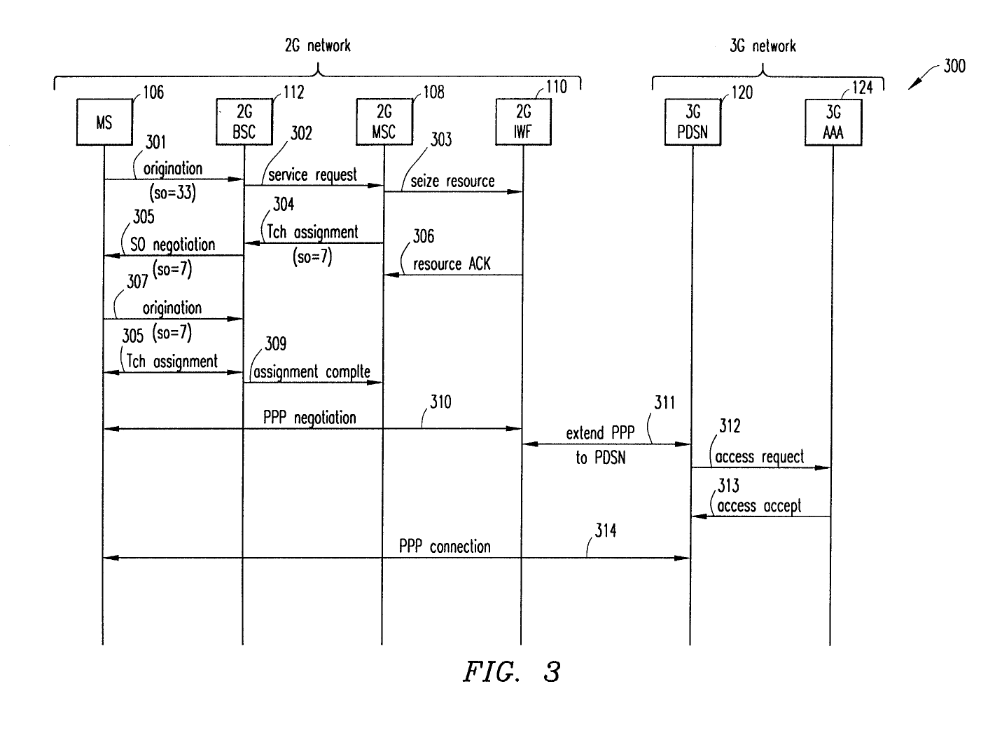

Reference is now made to FIG. 3, wherein there is shown a messaging diagram illustrating origination of 3G services by the mobile station 106 in accordance with the present invention. A message flow 300 begins when the mobile station 106, which is located in the 2G network, sends an origination message 301 to the base station controller 112. The origination message 301 includes a service option 33, which is a request for 144 kbps packet data service. The mobile station 106 could, in the alternative, request other 3G services via the origination message 301.

In response to the origination message 301, the base station controller 112 submits a service request 302 to the mobile switching center 108 for the 144 kbps packet data service sought by the mobile station 106. In response to the service request 302, the mobile switching center 108 seizes resources 303 on the interworking function 110 in order to fulfill the service request 302 for the 144 kbps packet data service.

Next, the mobile switching center 108 sends a traffic channel (T_{ch}) assignment message 304 to the base station controller 112. The traffic channel assignment message 304 includes a service option 7, which is for packet data services, but at a lower data rate than requested by the mobile station 106. The service option 7 is included in the traffic channel assignment message 304 because the 2G network does not support the high-speed data services designated by the service option 33.

Next, the base station controller 112 sends a service option negotiation message 305 to the mobile station 106. The service option negotiation message 305 also includes service option 7, which informs the mobile station 106 that the service option 33 is not available but that the service option 7 is available. Service option 7 indicates that 3G packet data services are available at a slower speed than the 144 kbps services designated by the service option 33. The 2G network sends the service option 7 because the 2G network does not support 144 kbps services but does support packet data services at a slower speed.

In response to the seize resource message 303 from the mobile switching center 108 to the interworking function 110, the interworking function 110 acknowledges that resources have been allocated for the mobile station 106 by a resource acknowledgment message 306. Next, the mobile station 106 sends an origination message (with service option 7) 307 to the base station controller 112. In response to the origination message (with service option 7) 307, a traffic channel assignment 308 between the base station controller 112 and the mobile station 106 occurs. The traffic channel assignment 308 between the mobile station 106 and the base station controller 112 typically comprises a plurality of messages as indicated in FIG. 3 by the two-headed arrow associated with the traffic channel assignment 308.

Following the traffic channel assignment 308, the base station controller 112 sends an assignment complete message 309 to the mobile switching center 108. The assignment complete message 309 notifies the mobile switching center 108 that the traffic channel assignment 308 between the mobile station 106 and the base station controller 112 is complete. Next, a PPP negotiation 310 between the mobile station 106 and the interworking function 110 takes place. The PPP negotiation 310 typically comprises a plurality of messages as indicated by the two-headed arrow associated with the PPP negotiation 310.

Next, the interworking function 110 performs an extension 311 of the PPP negotiation 310 to the PDSN 120, which is located in the 3G network. In response to the extension 311 of the PPP negotiation 310 to the PDSN 120, the PDSN 120 submits an access request 312 to the AAA server 124. In response to the access request 312, the AAA server 124 sends an access accept message 313 to the PDSN 120. Next, a PPP connection 314 is established between the PDSN 120 and the mobile station 106.

Messages 301-309 describe air interface procedures for access by the mobile station 106 of 3G services while operating in the 2G network. The mobile station 106 submits the origination request 301 for the service option 33 and is offered the service option 7 instead because the 2G network does not support the service option 33. The mobile station then submits the origination request 307 for the service option 7 as offered. Thereafter, the traffic channel is assigned (messages 308) and the mobile station 106 is connected to the interworking function 110 via the mobile switching center 108.

Messages 310-313 show that the mobile station 106 performs a PPP negotiation 310 with the interworking function 110; however, because the interworking function 110 cannot authenticate and authorize the mobile station 106 through an AAA server, the PDSN 120 in the 3G network can be used for that purpose. The interworking function 110 extends (message 310) the PPP negotiation 311 to the packet data service node 120 and thereby allows point-to-point protocol negotiation as well as authentication, authorization and accounting services to be provided via the packet data service node 120. At the message 314, the point-to-point protocol connection is established between the mobile station 106 and the packet data service node 120 via the interworking function 110. If the mobile station 106 requests mobile Internet Protocol (mobile IP) services, the packet data service node 120 provides the functionality of a 3G home or foreign agent.

It can thus be seen from FIG. 3 that the mobile station 106 in the 2G network can request 3G services, such as, for example, voice over IP (voIP) or IP multi-media, from the packet data service node 120 in the 3G network. The mobile station 106 negotiates the point-to-point protocol connection with the packet data service node 120 via the interworking function 110. After the mobile station 106 has been authenticated and authorized, the point-to-point protocol connection 314 between the packet data service node 120 and the mobile station 106 occurs.

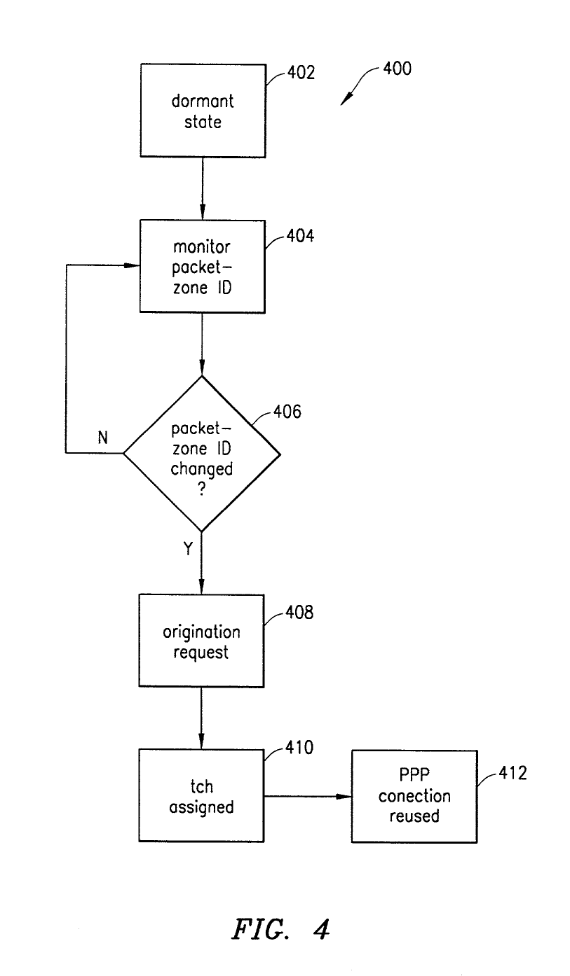

Reference is now made to FIG. 4, wherein there is shown a flow chart illustrating how the mobile station 106, in response to roaming from the 2G network to the 3G network, can undergo a dormant handoff between the 2G network and the 3G network. Although FIG. 4 illustrates roaming from the 2G to the 3G network, those skilled in the art will recognize that the principles of FIG. 4 can also be applied to the reverse operation of roaming from the 3G to the 2G network.

A process 400 begins at step 402, wherein the mobile station 106 has completed the call flow 300 as illustrated by FIG. 3 and has entered a dormant state due to the mobile station 106 not having sent or received data for a predetermined time period, the dormant state causing the traffic channel assigned at the message 308 to be released so that radio resources are not wasted on the mobile station 106.

From step 402, execution proceeds to step 404. At step 404, even though the mobile station 106 is in the dormant state, the mobile station 106 monitors a control channel for a packet zone identification broadcast by the 2G network. Although the traffic channel has been released, all other resources negotiated during the flow 300 remain available to the mobile station 106, including the PPP connection 314, so that if the mobile station 106 becomes active again, the complete flow 300 need not be repeated. From step 404, execution proceeds to step 406. At step 406, a determination is made whether the packet zone identification (packet zone ID) monitored by the mobile station 106 on the control channel has changed. If it is determined that the packet zone ID has not changed, execution moves to step 404. Upon entering the 3G network, the mobile station 106 detects a new packet zone identification (i.e., for the 3G network) on the control channel, which results in a determination at step 406 that the packet zone ID has changed. If, at step 406, it is determined that the packet zone ID has changed, execution proceeds to step 408. At step 408, the mobile station 106 begins a process similar to the process 300 by issuing an origination request 301 (with service option 33) to the BSC 122 of the 3G network.

From step 408, execution proceeds to step 410. At step 410, a new traffic channel in the 3G network is assigned to the mobile station 106. The new traffic channel is assigned between the BSC 122 and the mobile station 106 because the traffic channel assigned in the message 308 has been released and also because the mobile station is now in the 3G network and not in the 2G network. From step 410, execution proceeds to step 412.

Because the mobile station 106 is located in the packet zone of the PDSN 120 and the PPP connection 314 previously negotiated in the 2G network is still present, a new PPP connection between the mobile station 106 and the PDSN 120 need not be negotiated. Therefore, at step 412, the PDSN 120 reuses the previously-negotiated PPP connection 314 to connect to the mobile station 106 via the BSC 122. Because the 3G network supports 3G services, the service option 33 request of the mobile station 106 is granted, in contrast to FIG. 3.

It can thus be seen from FIG. 4 that the present invention supports dormant roaming of the mobile station between the 2G and the 3G networks. Because the same PDSN is used, PPP renegotiation need not take place following entry of the mobile station into the 3G network.

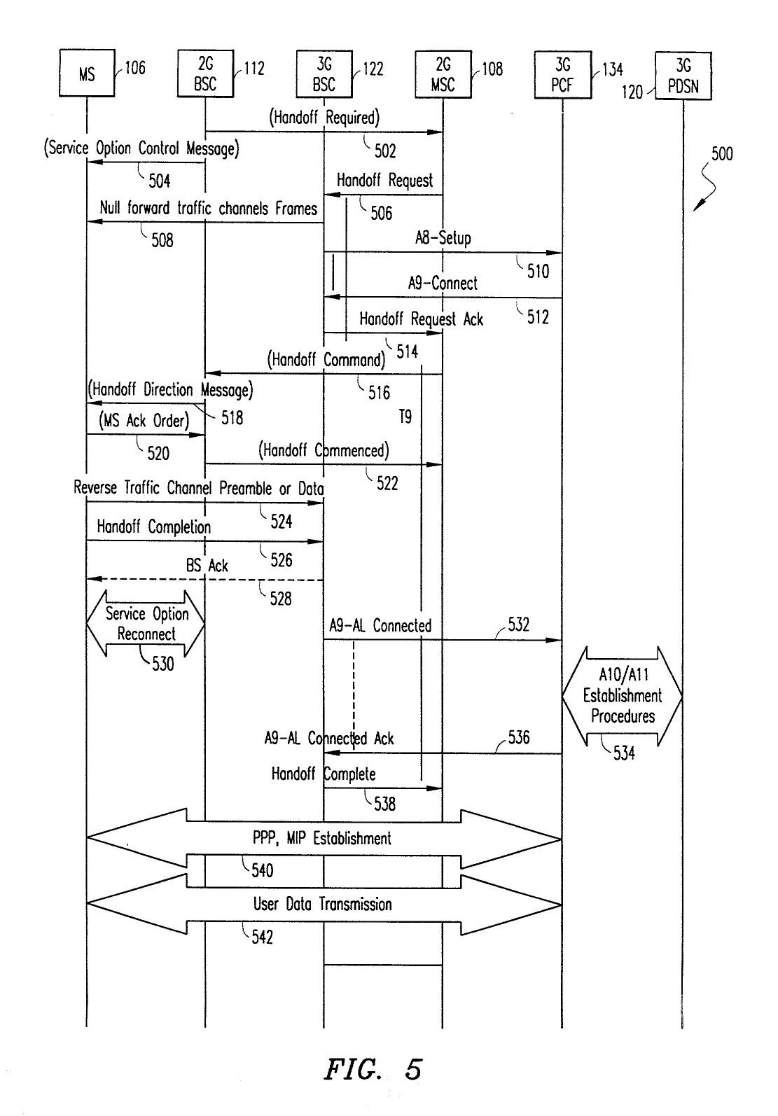

Reference is now made to FIG. 5, wherein there is shown a messaging diagram illustrating a hard handoff of a mobile station roaming from a second-generation network to a third-generation network in accordance with the present invention. Although FIG. 5 illustrates roaming from the 2G to the 3G network, those skilled in the art will recognize that the principles of FIG. 5 can also be applied to the reverse operation of roaming from the 3G to the 2G network.

It is assumed for purposes of FIG. 5 that the mobile station 106 has previously accessed the 2G network according to the process 300, is in an active state, and is moving towards the 3G network, which is served by the packet data service node 120. A call flow 500 shows existing procedures for hard handoffs as described in the IOS 2001 standard. Hard handoffs, as opposed to dormant handoffs, must be used by mobile stations that are in the active state.

As the mobile station 106 moves toward the 3G network, the BSC 112 sends a handoff required message 502 to the MSC 108, informing the MSC 108 that the mobile station 106 needs to be handed off. Note that the process 500 is network-initiated, while the dormant handoff process 400 and the origination process 300 are mobile-station-initiated. The BSC 112 also sends a service option control message 504 to the mobile station. In response to the handoff required message 502, the MSC 108 sends a handoff request to message 506 to the BSC 122, requesting that the BSC 122 accept handoff of the mobile station 106. In response to the handoff request message 506, the BSC 122 sends a null forward traffic channels frames message 508 to the mobile station 106.

Next, the BSC 122 sends an A8 setup message 510 to the PCF 134, the BSC 122 and the PCF 134 being most typically co-located as shown in FIG. 1. In response to the A8 setup message 510, the PCF 134 sends an A9 connect message 512 to the BSC 122. Next, the BSC 122 sends a handoff request acknowledgment message 514 to the MSC 108, thereby acknowledging the handoff request message 506 from the MSC 108.

Next, the MSC 108 sends a handoff command 516 to the MSC 112, commanding the BSC 112 to send a handoff direction message 518 to the mobile station 106. In response to the handoff command 516, the BSC 112 sends the handoff direction message 518 to the mobile station 106. The mobile station 106 responds to the handoff direction message 518 by sending a mobile station acknowledgment order message 520 to the BSC 112.

Thereafter, the handoff is commenced, as shown by the handoff commenced message 522 from the BSC 112 to the MSC 108. Next, the mobile station 106 sends reverse traffic channel preamble or data 524 to the BSC 122. The mobile station 106 also sends a handoff completion message 526 to the BSC 122. The BS 122 acknowledges the mobile station 106 by a BS acknowledgment message 528.

Next, a service option reconnect negotiation 530 occurs. The BSC 122 sends an A9/AL connected message 532 to the PCF 134. Thereafter, A10/A11 establishment procedures 534 occur between the PCF 134 and the PDSN 120. Next, the PCF 134 sends an A9/AL connection acknowledgment message 536 to the BSC 122. In response to the message 536, the BSC 122 sends a handoff complete message 538 to the MSC 108.

Thereafter, PPP and/or mobile IP occur between the mobile station 106 and the PCF 134 as shown by double headed arrow 540. User data transmission between the mobile station 106 and the PCF 134 is thereby effectuated, as shown by the double headed arrow associated with user data transmission 542.

Because the PDSN 120 has already negotiated the PPP connection 314 with the mobile station 106 while the mobile station was located in the 2G network, it is not necessary for the PDSN 120 to renegotiate the PPP connection 314. Rather, in a fashion somewhat similar to that described with respect to FIGS. 3 and 4, the PPP connection 314 is merely moved from the interworking function 110 to the BSC 122 and a traffic channel is set up between the mobile station 128 and the BSC 122. Therefore, the present invention allows existing hard handoff procedures to be followed.

It can thus be seen from FIG. 5 that the packet data service node 120 does need to renegotiate the PPP connection 314 established in the 2G network between the mobile station 106 and the PDSN 120 but rather merely moves the PPP connection 314 from the interworking function 110 to the 3G BSC 122. Mobile IP registration, if any, of the mobile station 106 will not be reinitialized but will instead be maintained. In essence, the packet data service node 120 becomes access-independent and handles mobility between the 2G network and the 3G network by moving the PPP connection 314 to a new interface (i.e., the connection 126) where the mobile station 106 is now located.

Although preferred embodiments of the methods and systems of the present invention have been illustrated in the accompanying Drawings and described in the foregoing Description, it will be understood that the present invention is not limited to the embodiments disclosed, but is capable of numerous rearrangements, modifications, and substitutions without departing from the spirit and the scope of the present invention as set forth by the following claims.

What is claimed is:

1. A method of providing packet data services comprising the steps of:
requesting of packet-data services by a user located in a first network;
assigning access resources to the user in an inter-working function of the first network;
establishing by the inter-working function of a link to a packet data service node in a second network;
negotiating via the inter-working function of a point-to-point protocol connection between the user in the first network and the packet data service node in the second network; and
providing the packet data services to the user via the inter-working function by the packet data service node.

2. The method of claim 1 wherein the packet data service node serves as a network access server to the interworking function.

3. The method of claim 1 further comprising the steps of:
roaming by the mobile station from the first network to the second network;
performing a handoff of the mobile station to the second network; and
reusing by the packet data service node of the previously-established point-to-point connection between the mobile station and the packet data service node following the step of performing the handoff.

4. The method of claim 3 wherein the handoff is a dormant handoff.

5. The method of claim 3 wherein the handoff is a hard handoff.

6. The method of claim 1 wherein the first network is a second-generation code-division-multiple-access network and the second network is a third-generation code-division-multiple-access network.

7. The method of claim 1 wherein the first network and the second network are both second-generation code-division-multiple-access networks.

8. The method of claim 1 further comprising the step of accessing by the mobile station, via the packet data service node, of authentication, authorization, and accounting (AAA) services from an AAA server located in the second network.

9. A system for providing packet data services comprising:
an inter-working function located in a first network and serving as a transition node between a packet data service node located in a second network and at least one mobile station;
a packet data service node located in the second network and interoperably connected to the inter-working function; and
at least one mobile station located in the first network and interoperably connected to the inter-working function, wherein the at least one mobile station receives services from the packet data service node via the interworking function.

10. The system of claim 9 wherein the packet data service node serves as a network access server to the interworking function.

11. The system of claim 9 wherein the packet data service node reuses a previously-established point-to-point connection between the mobile station and the packet data service node following a handoff of the mobile station from the first network to the second network.

12. The system of claim 11 wherein the handoff is a dormant handoff.

13. The system of claim 11 wherein the handoff is a hard handoff.

14. The system of claim 9 wherein the first network is a second-generation code-division-multiple-access network and the second network is a third-generation code-division-multiple-access network.

15. The system of claim 9 wherein the first network and the second network are both second-generation code-division-multiple-access networks.

16. The system of claim 9 the mobile station accesses, via the packet data service node, authentication, authorization, and accounting (AAA) services from an AAA server located in the second network.

17. An inter-working function located in a first network and interoperably connected to a packet data service node located in a second network and to at least one mobile station located in the first network, wherein the inter-working function serves as a transition node between the at least one mobile station and the packet data service node for provision of packet data services by the packet data service node to the at least one mobile station.

18. The system of claim 17 wherein the packet data service node serves as a network access server to the interworking function.

19. The system of claim 17 wherein the packet data service node reuses a previously-established point-to-point connection between the mobile station and the packet data service node following a handoff of the mobile station from the first network to the second network.

20. The system of claim 19 wherein the handoff is a dormant handoff.

21. The system of claim 19 wherein the handoff is a hard handoff.

22. The system of claim 17 wherein the first network is a second-generation code-division-multiple-access network and the second network is a third-generation code-division-multiple-access network.

23. The system of claim 17 wherein the first network and the second network are both second-generation code-division-multiple-access networks.

24. The system of claim 17 the mobile station accesses, via the packet data service node, authentication, authorization, and accounting (AAA) services from an AAA server located in the second network.
